(19) United States
(12) Patent Application Publication
(10) Pub. No.: US 2018/0143586 A1
(43) Pub. Date: May 24, 2018

(54) Volume Phase Holographic Grating

(71) Applicants: Francesco Narducci, Huntingtown, MD (US); Adoum Mahamat, Lexington Park, MD (US)

(72) Inventors: Francesco Narducci, Huntingtown, MD (US); Adoum Mahamat, Lexington Park, MD (US)

(73) Assignee: United States of America as represented by the Secretary of the Navy, Patuxent River, MD (US)

(21) Appl. No.: 15/358,398

(22) Filed: Nov. 22, 2016

(51) Int. Cl. G03H 1/02

(52) U.S. Cl. CPC G03H 1/0248; G03H 2001/026; G03H 2223/50; G03H 1/0252

(57) ABSTRACT

A volume phase holographic grating includes two cover shields and a holographic optical member. The holographic optical member is created by taking gel and having two lasers interfere with each other on the gel such that a pattern is created on the gel. The optical member placed between the two cover shields such that the optical member is protected.

### STATEMENT OF GOVERNMENT INTEREST

The invention described herein may be manufactured and used by or for the Government of the United States of America for governmental purposes without payment of any royalties thereon or therefor.

### BACKGROUND

Volume holograms are three dimensional records of amplitude and phase information of electromagnetic waves inside an optical material. The recording is done by interfering two coherent waves having the same polarization. Volume holograms have been used in many applications for their diffractive nature. They have been used for applications in optical communication, electro-optical and infrared imaging systems, and astronomy.

Diffraction in a volume hologram is characterized by several factors which include high diffraction efficiency, sensitivity to reconstruction wavelength and angular misalignment, and polarization dependence of the diffraction efficiency.

Most volume holograms are designed to operate with high efficiency at the Bragg wavelength and can be optimized for other wavelengths by changing the incidence angle. These types of holograms do not guarantee higher efficiencies at wavelengths other than the Bragg wavelength; thus, they are designed for operation at a single wavelength.

### SUMMARY

The present invention is directed to a volume phase holographic grating with needs enumerated above and below.

The present invention is directed to a volume phase holographic grating which includes two cover shields and a holographic optical member. The holographic optical member is created by taking gel and having two lasers interfere with each other on the gel such that a pattern is created on the gel. The optical member placed between the two cover shields such that to the optical member is protected.

It is a feature of the present invention to provide a holographic grating that is optimized to produce 98% efficiency at a wavelength of about 532 nm and at least 75% efficiency in the region between 400 nm and 700 nm, when the incident light is unpolarized.

It is a feature of the present invention to provide a holographic grating that can operate at multiple wavelengths at the same time and to provide high diffraction efficiencies.

It is a feature of the present invention to provide a holographic grating that can be utilized as, but without limitation, a lens to miniaturize optical systems, a heads up display, and used in lidar technologies, photonics, or any other technology practicable.

### DRAWINGS

These and other features, aspects and advantages of the present invention will become better understood with reference to the following description and appended claims, and accompanying drawings wherein:

FIG. 1 is a drawing of an un-slanted transmission volume phase hologram;

FIG. 2 is a graph that shows the plots of diffraction efficiency versus wavelength for all three Bragg's angles determine using wavelength values of 460 nm, 532 nm, and 632 nm; and,

FIG. 3 is a graph that shows blazed curves for multiple incidence angles, and the super blazed curve that shows the overall performance of the hologram for wavelengths between 400 nm and 700 nm.

### DESCRIPTION

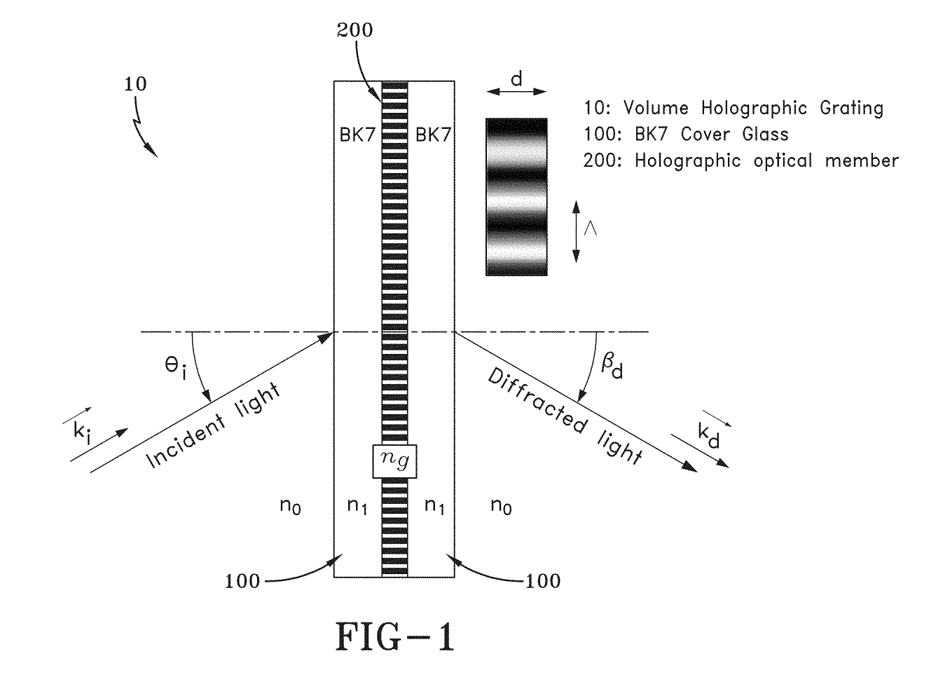

The preferred embodiments of the present invention are illustrated by way of example below and as shown in FIG. 1-3. As shown in FIG. 1, the volume phase holographic grating 10 includes two cover shields 100 and a holographic optical member 200. The holographic optical member 200 is created by taking gel and having two lasers interfere with each other on the gel such that a pattern is created on the gel. The optical member 200 placed between the two cover shields 100 such that the optical member 200 is protected.

In the preferred embodiment, the optical member 200 is created by interfering two coherent beams inside a dichromated gelatin thin film having a thickness of about 12 microns. The optical member 200 may be placed between the two Bk7 cover glasses (cover shields 100) of thickness of about 3 mm such that the optical member 200 is protected from humidity, dust, and physical damage.

In the description of the present invention, the invention will be discussed in a military environment; however, this invention can be utilized for any type of application that utilizes a holographic grating or transmission surface relief grating.

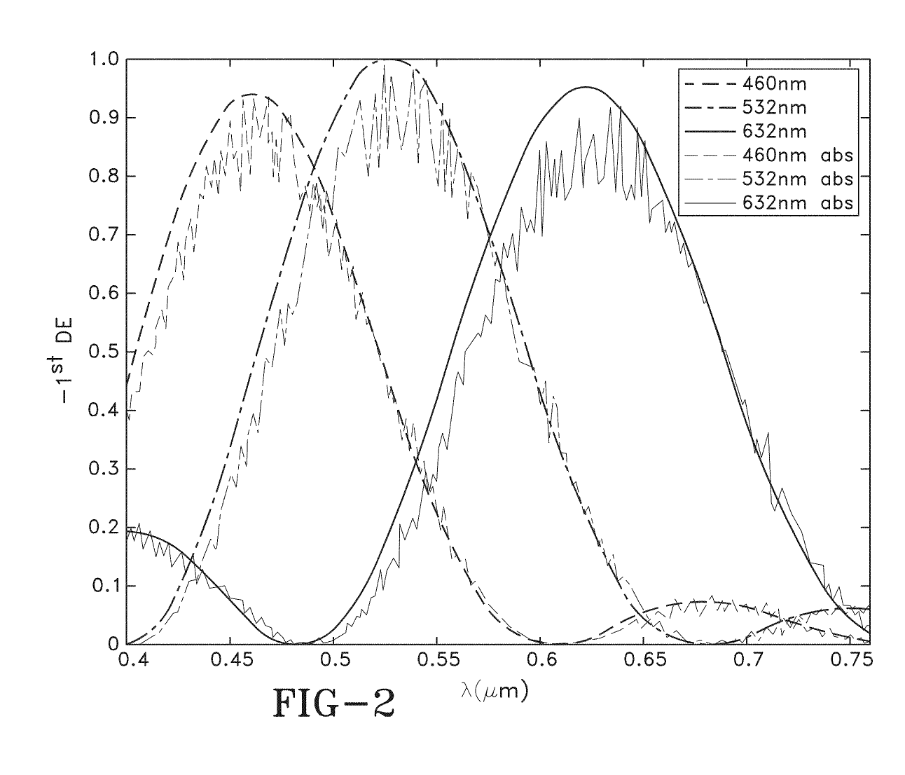

In the preferred embodiment, an un-slanted volume hologram is sandwiched between two BK7 cover glasses of thickness about 3 mm each. FIG. 2 shows the plots of diffraction efficiency versus wavelength for all three Bragg's angles determine using wavelength values of 460 nm, 532 nm, and 632 nm. The smooth curves represent the diffraction efficiencies determined without consideration of absorption from the BK7 cover glasses. When absorption from cover glasses is considered, the curves are no longer smooth.

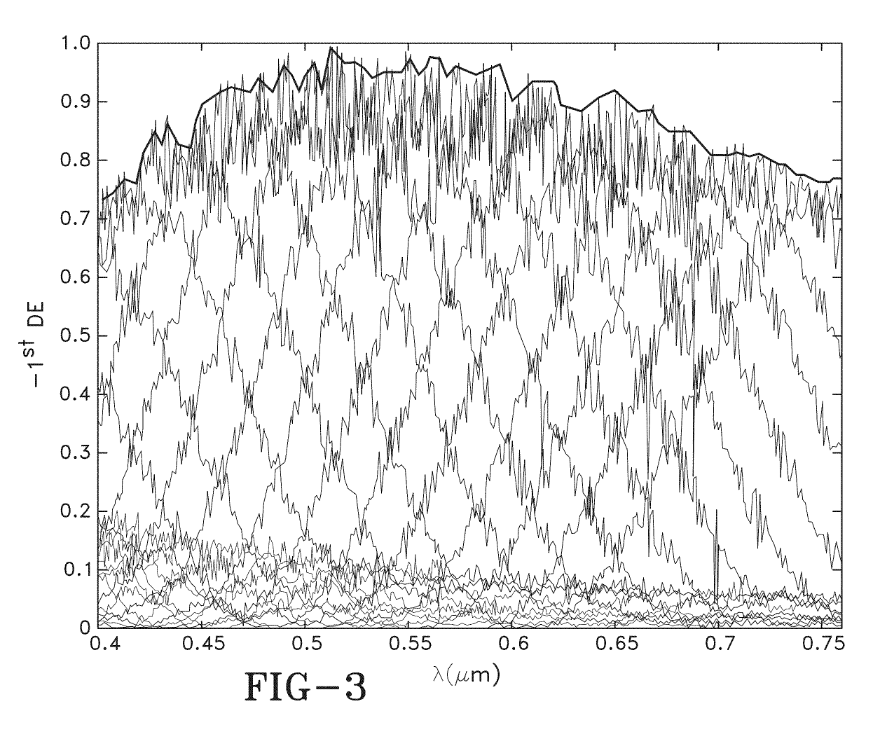

FIG. 3 depicts the blazed curves for multiple incidence angles. The blazed curves are the diffraction efficiency plots at different incident gating angles and have their maxima at their respective wavelengths according to the Bragg's condition. The envelope resulting from the blazed curves is the super blaze curve. This envelope explains the fact that this volume hologram is designed for operation for all wavelengths between about 400 and about 700 nm, and can also give diffraction efficiencies higher than about 75% for the entire visible spectrum.

The preferred gel is dichromated gelatin and optimized to provide diffraction efficiencies higher than about 75% for all visible wavelengths, and higher than about 90% for blue, green, and red light when incident light is unpolarized. The preferred gel utilized in the grating 10 is also dichromated gelatin which has an average refractive index of about 1.5, a refractive index modulation of about 0.022, and a thickness of about 12 micrometers.

When introducing elements of the present invention or the preferred embodiment(s) thereof, the articles “a,” “an,” “the,” and “said” are intended to mean there are one or more of the elements. The terms “comprising,” “including,” and “having” are intended to be inclusive and mean that there may be additional elements other than the listed elements.

Although the present invention has been described in considerable detail with reference to certain preferred embodiments thereof, other embodiments are possible. Therefore, the spirit and scope of the appended claims should not be limited to the description of the preferred embodiment(s) contained herein.

What is claimed is:

1. A volume phase holographic grating comprising:
two cover shields; and,
an holographic optical member, the member created by taking gel and having two lasers interfere with each other on the gel such that a pattern is created on the gel; the optical member placed between the two cover shields such that the optical member is protected.

2. The volume phase holographic grating of claim 1, wherein the gel is dichromated gel.

3. A volume phase holographic grating comprising:
two cover shields; and,
an holographic optical member, the member created by taking dichromatic gel and having two lasers interfere with each other on the dichromatic gel such that a pattern is created on the dichromatic gel; the optical member placed between the two cover shields such that the optical member is protected, the dichromated gel has an average refractive index of about 1.5 and a refractive index modulation of about 0.022.

4. The volume phase holographic grating of claim 3, wherein the gel is dichromated gelatin and optimized to provide diffraction efficiencies higher than about 75% for all visible wavelengths, and higher than about 90% for blue, green, and red light when incident light is unpolarized.

5. The volume phase holographic grating of claim 4, wherein the dichromated gelatin has an average refractive index of about 1.5 and a refractive index modulation of about 0.022 and a thickness of 12 microns.
